(19) United States
(12) Patent Application Publication
(10) Pub. No.: US 2011/0300845 A1
(43) Pub. Date: Dec. 8, 2011

(54) MOBILE TERMINAL AND METHOD OF CONTROLLING FUNCTION THEREOF

(75) Inventor: Dong Yup LEE, Seoul (KR)

(73) Assignee: SAMSUNG ELECTRONICS CO. LTD., Suwon-si (KR)

(21) Appl. No.: 13/154,639

(22) Filed: Jun. 7, 2011

(30) Foreign Application Priority Data
Jun. 7, 2010 (KR) 10-2010-0053349

(51) Int. Cl. H04W 4/00; H04W 88/02; G06F 3/041

(52) U.S. Cl. 455/418; 345/173; 455/556.1

(57) ABSTRACT

A method of controlling a function of a portable terminal having a touch screen is provided. In the method, ultrasonic waves are outputted through a speaker when a communication event is performed. Whether the outputted ultrasonic waves are inputted through a microphone is determined. A lock function of the touch screen is performed when the outputted ultrasonic waves are inputted through the microphone.

### PRIORITY

This application claims the benefit under 35 U.S.C. §119(a) of a Korean patent application filed on June 7, 2010 in the Korean Intellectual Property Office and assigned Serial No. 10-2010-0053349, the entire disclosure of which is hereby incorporated by reference.

### BACKGROUND OF THE INVENTION

1. Field of the Invention:

The present invention relates to a portable terminal and a method of controlling a function thereof More particularly, the present invention relates to a portable terminal and a method of performing a certain function by measuring a distance between the portable terminal and a user when performing a call.

2. Description of the Related Art:

A touch screen is a display unit that can be used as an input device. The touch screen is widely used for small size devices such as a portable terminal, mobile communication devices, and other similar electronic devices. In the portable terminal having the touch screen, an unwanted operation of the touch screen can be caused by inadvertent inputs from a user's body during a call. In order to prevent such unwanted operation, a proximity sensor can be used.

The proximity sensor includes a light emitting unit for emitting an infrared light and a light receiving unit for receiving a reflected infrared light. Thus, an operation of the touch screen is controlled based on a distance the reflected light travels between the light emitting unit and the light receiving unit.

However, using the proximity sensor for the portable terminal is disadvantageous in that the manufacturing cost of the portable terminal is increased due to a high cost of the proximity sensor. Moreover, a touch sensor of the touch screen is positioned on top of the proximity sensor, thereby limiting the operation of the proximity sensor. Moreover, the proximity sensor requires an additional component, which creats difficulty in installing the proximity sensor in the portable terminal.

### SUMMARY OF THE INVENTION

Aspects of the present invention are to address at least the above-mentioned problems and/or disadvantages and to provide at least the advantages described below.

In accordance with an aspect of the present invention, a method of controlling a function of a portable terminal having a touch screen is provided. The method includes, outputting ultrasonic waves through a speaker when a communication event is performed, determining whether the outputted ultrasonic waves are inputted through a microphone, and performing a lock function of the touch screen when the ultrasonic waves are inputted through the microphone.

Performing a lock function of the touch screen may include identifying an output time of the outputted ultrasonic waves and an input time of the inputted ultrasonic waves, when the inputted ultrasonic waves are inputted through the microphone, calculating a lock control value based on the identified output time of the outputted ultrasonic waves and the identified input time of the inputted ultrasonic waves, and performing the lock function according to the calculated lock control value.

Performing the lock function based on the calculated lock control value may include determining whether the calculated lock value is equal to or less than a preset threshold value to perform the lock function, determining whether the lock function is performed if the calculated lock value is greater than the preset threshold value, and releasing the lock function if the lock function is performed when the calculated lock value is greater than the preset threshold value.

The communication event may be one of a call originating event or a call receiving event.

In accordance with another aspect of the present invention, a mobile terminal is provided. The portable terminal includes, an audio processing unit for outputting ultrasonic waves through a speaker and for receiving the outputted ultrasonic waves through a microphone, when a communication event is performed, a touch screen for performing a lock function according to the ultrasonic waves inputted and outputted through the audio processing unit, when the communication event is performed, and a control unit for calculating a lock control value for performing the lock function according to an output time of the ultrasonic waves are outputted through the speaker and an input time of the ultrasonic waves are inputted through the microphone, and for controlling the touch screen based on the calculated lock control value to perform the lock function.

The control unit may determine whether the calculated lock value is equal to or less than a preset threshold value in order to perform the lock function.

The control unit may determine whether the lock function is performed on the touch screen if the calculated lock value is greater than the preset threshold value, and the control unit may release the lock function if the lock function is performed on the touch screen.

The communication event may be one of a call originating event or a call receiving event.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a configuration of a portable terminal according to an exemplary embodiment of the present invention;

FIG. 2 illustrates a configuration of an audio processing unit according to an exemplary embodiment of the present invention;

FIG. 3 illustrates a method of performing a lock function when performing a communication event according to an exemplary embodiment of the present invention; and

FIG. 4 illustrates a procedure of performing a lock function according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Particular terms may be defined herein to describe the invention in the best manner. Accordingly, the meaning of specific terms or words used in the specification and the claims should not be limited to the literal or commonly employed sense, but should be construed in accordance with the spirit of the invention.

A ‘portable terminal’ refers to an information processing apparatus, which is wiredly or wirelessly connected to an external terminal to transmit and receive various data therebetween.

A ‘communication event’ refers to an event in which a user's portable terminal transmits and receives voice data to/from a calling or called party's portable terminal The communication event includes a call originating event and a call receiving event.

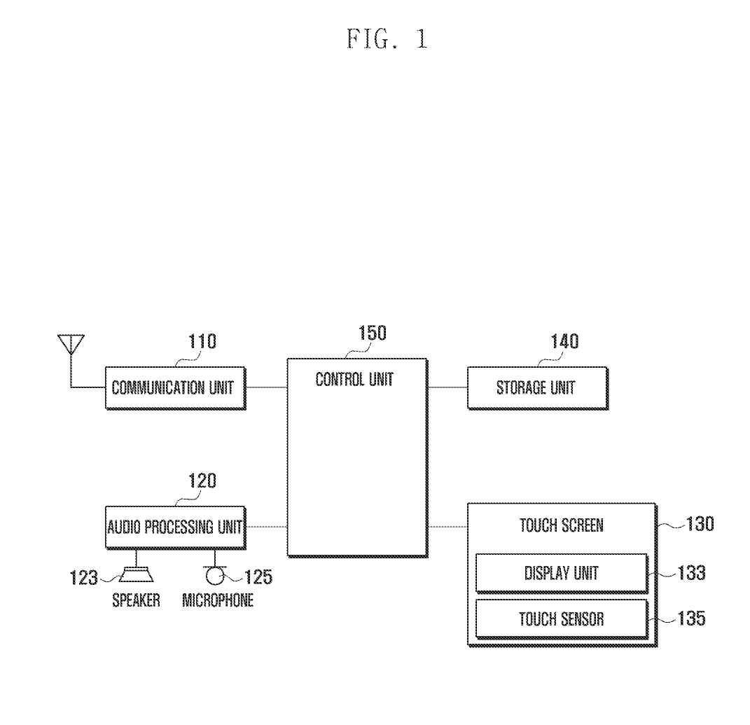

FIG. 1 illustrates a configuration of a portable terminal according to an exemplary embodiment of the present invention.

Referring to FIG. 1, the portable terminal includes a communication unit 110, an audio processing unit 120, a touch screen 130, a storage unit 140 and a control unit 150.

The communication unit 110 performs radio frequency communication between the portable terminal and a base station (not shown). The communication unit 110 can include other elements not shown in FIG. 1, including a duplexer that isolates a receiver from a transmitter, the transmitter that performs a frequency up conversion of a transmission signal, and the receiver that performs a frequency down conversion of a received signal. In addition, the communication unit 110 can perform short range communication using various communication protocols, such as Bluetooth, or Wireless-Fidelity (Wi-Fi) for wireless communication in a Local Area Network (LAN).

The audio processing unit 120 includes a speaker 123 and a microphone 125. The audio processing unit 120 converts sound data, which is received from the control unit 150, into sound waves through the speaker 123 such that a sound signal is outputted. Also, the audio processing unit 120 modulates a sound signal received through the microphone 125 to convert the sound signal into the sound data to be transmitted to the control unit 150. Additionally, when the communication event is performed, the audio processing unit 120 outputs ultrasonic waves through the speaker 123 and receives the ultrasonic waves through the microphone 125, under the control of the control unit 150. The audio processing unit 120 can convert user voice data and a calling or called party's voice data into a voice signal to be outputted through the speaker 123 together with the ultrasonic waves.

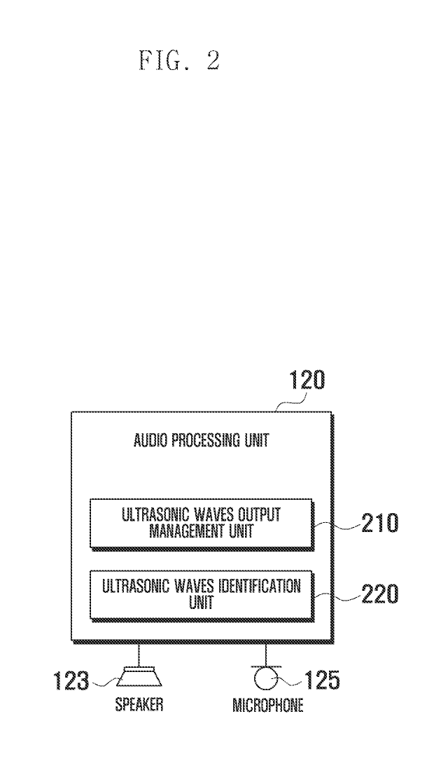

In addition, the audio processing unit 120 distinguishes the user voice signal from the ultrasonic waves inputted together through the microphone 125. The audio processing unit 120 modulates the voice signal into voice data and notifies the control unit 150 that the ultrasonic waves are received. The audio processing unit 120, according to the present exemplary embodiment, will be described later with reference to FIG. 2.

The touch screen 130 includes a display unit 133 and a touch sensor 135. The display unit 133 can display various information related to a status, an application and an operational state of the portable terminal The touch sensor 135, which is mounted on the display unit 133, detects an input event that occurs when a user's finger or an input tool touches the display unit 133 or when a touch is released. Upon the touching of the display unit 133 occurring, the touch sensor 135 notifies the control unit 150 about the generated input event. According to the present exemplary embodiment, when the communication event is performed, the touch screen 130 performs a lock function under the control of the control unit 150. The lock function controls the operation of the portable terminal by cutting off power supplied to the display unit 133 and the touch sensor 135.

The storage unit 140 stores various applications that can be activated and executed on the portable terminal, stores various data generated by the activated application or user, and may store a variety of other data. In the present exemplary embodiment, the storage unit 140 stores the ultrasonic waves outputted through the speaker 123 during the performing of the communication event. The ultrasonic waves are a sound source having a frequency that is equal to or higher than 20 kHz. The ultrasonic waves are periodically outputted through the speaker 123 under the control of the control unit 150 when performing the communication event.

The control unit 150 controls an overall state and operation of each component of the portable terminal Here, the control unit 150 calculates a lock control value using the ultrasonic waves inputted from or outputted to the speaker 123 and the microphone 125 of the audio processing unit 120. The lock control value enables the lock function of the touch screen 130. More specifically, when the communication event is generated, the control unit 150 controls the audio processing unit 120 to periodically output the ultrasonic waves through the speaker 123. The period of the output of the ultrasonic waves can be set by a manufacturer or a user of the portable terminal In the present exemplary embodiment, the period of the output of the ultrasonic waves is 300 milliseconds (ms), however, aspects of the invention are not limited thereto, and the period of the output of the ultrasonic waves may be any suitable time period. The control unit 150 detects a time when the ultrasonic waves are outputted, and the control unit 150 may record the time at which the ultrasonic waves are outputted. Next, when the ultrasonic waves are inputted to the microphone 125 of the audio processing unit 120, the control unit 150 detects a time when the ultrasonic waves are inputted into the microphone 125.

According to another exemplary embodiment of the present invention, the control unit 150 determines whether the ultrasonic waves inputted to the microphone 125 are similar to the ultrasonic waves outputted by the speaker 123 by comparing a period of the outputted ultrasonic waves to a period of the inputted ultrasonic waves. However, the present invention is not limited thereto and the control unit 150 may verify that a frequency range of the ultrasonic waves outputted by the speaker 123 are similar or equal to a frequency range of the ultrasonic waves inputted by the microphone 125.

Next, the control unit 150 calculates the lock control value based on the output time of the ultrasonic waves and the input time of the ultrasonic waves. The lock control value can be expressed as a distance that the ultrasonic waves travel or as a time difference between the output time and the input time of the ultrasonic waves. When the lock control value is expressed as a distance, the lock control value can be calculated based on the output time and input time of the ultrasonic waves. Here, the control unit 150 can calculate the distance the ultrasonic waves travel by using the following Equation 1:

I=f×λ×t (1)

wherein I represents the distance the ultrasonic waves travel, f represents a frequency of the ultrasonic waves, λ represents a wavelength of the ultrasonic waves, and t represents a time difference between the output time and the input time of the ultrasonic waves.

The control unit 150 controls the lock function of the touch screen 130 based on the calculated lock control value. In other words, when the lock control value is calculated, the control unit 150 determines whether the lock control value is equal to or less than a preset threshold value. If the lock control value is equal to or less than the preset threshold value, the control unit 150 controls the touch screen 130 to activate the lock function. Accordingly, when performing the communication event, if the lock control value is equal to or less than the preset threshold value, it is determined that the portable terminal is located near a part of a user's body that is not executing a touch input on the touch screen 130. More particularly, when the user brings the portable terminal into contact with the part of the user's body during the communication event, the lock control value has a value equal to or less than the preset threshold value. In addition, the preset threshold value can be determined by various experiments during a manufacturing process of the portable terminal Alternatively, the user can set the threshold value. In addition, when the lock control value is calculated as the distance the ultrasonic waves travel, the preset threshold value is preferably 4 centimeters (cm). However, the present invention is not limited thereto, and the preset threshold value may be determined or set in any suitable manner and the preset threshold value may be any suitable value.

When the lock control value is greater than the preset threshold value, the control unit 150 determines whether the lock function of the touch screen 130 is activated. In other words, the control unit 150 determines whether power is supplied to the touch screen 130. If the lock function of the touch screen is activated, the control unit 150 controls the touch screen 130 to release the lock function. In other words, the control unit 150 returns to supplying power to the touch screen 130.

When performing the communication event, the portable terminal having the above configuration can perform the lock function by using the ultrasonic waves outputted from the speaker 123 and inputted through the microphone 125 that constitute the audio processing unit 120. The audio processing unit 120 that outputs and receives the ultrasonic waves is described in more detail with reference to FIG. 2.

FIG. 2 illustrates a configuration of an audio processing unit according to an exemplary embodiment of the present invention.

Referring to FIG. 2, the audio processing unit 120 includes an ultrasonic waves output management unit 210 and an ultrasonic waves identification unit 220.

When performing the communication event, the ultrasonic waves output management unit 210 outputs the ultrasonic waves through the speaker 123 according to a certain period, under the control of the control unit 150.

The ultrasonic waves identification unit 220 includes a filter to separate the ultrasonic waves from a voice signal inputted through the microphone 125. According to the present exemplary embodiment, the voice signal has a frequency range of 100 to 450 Hz and the ultrasonic waves have a frequency range equal to or higher than 20 kHz. In other words, the voice signal can be separated from the ultrasonic waves according to the respective frequency ranges. Therefore, it is preferable that the ultrasonic waves identification unit 220 includes a filter for filtering a frequency in a range of 100 to 450 Hz and a filter for filtering a frequency equal to or higher than 20 kHz. In addition, the ultrasonic waves identification unit 220 can include a filter for filtering a noise inputted through the microphone 125. However, the present invention is not limited thereto, and the ultrasonic waves identification unit 220 may include a variety of suitable filters to filter a variety of suitable frequency ranges.

The ultrasonic waves identification unit 220 converts a filtered voice signal into a voice data to be transmitted to the control unit 150. Here, the ultrasonic waves identification unit 220 can also transmit information of the presence of filtered ultrasonic waves to the control unit 150.

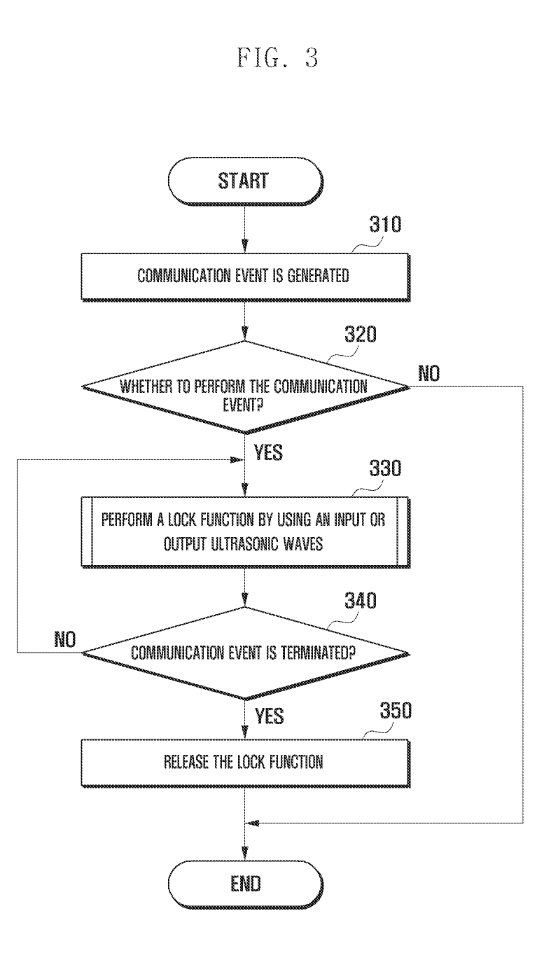

FIG. 3 illustrates a method of performing a lock function when performing a communication event according to an exemplary embodiment of the present invention.

Referring to FIG. 3, when the communication event is generated in step 310, the control unit 150 determines whether to perform the communication event in step 320. In the present exemplary embodiment, the communication event may include a call originating event and a call receiving event. The communication event is generated when the user enters a telephone number to originate a call or when the call is received from a calling party. However, aspects of the invention are not limited thereto, and the communication event can be a variety of communication operations performed on the portable terminal, such as a video conference or other such communication events and operations. To determine whether the communication event is selected to be performed, it is determined whether a “send” button is pressed so as to originate a call to a called party after entering the called party's telephone number or whether the called party accepts the call when the call is received by the called party.

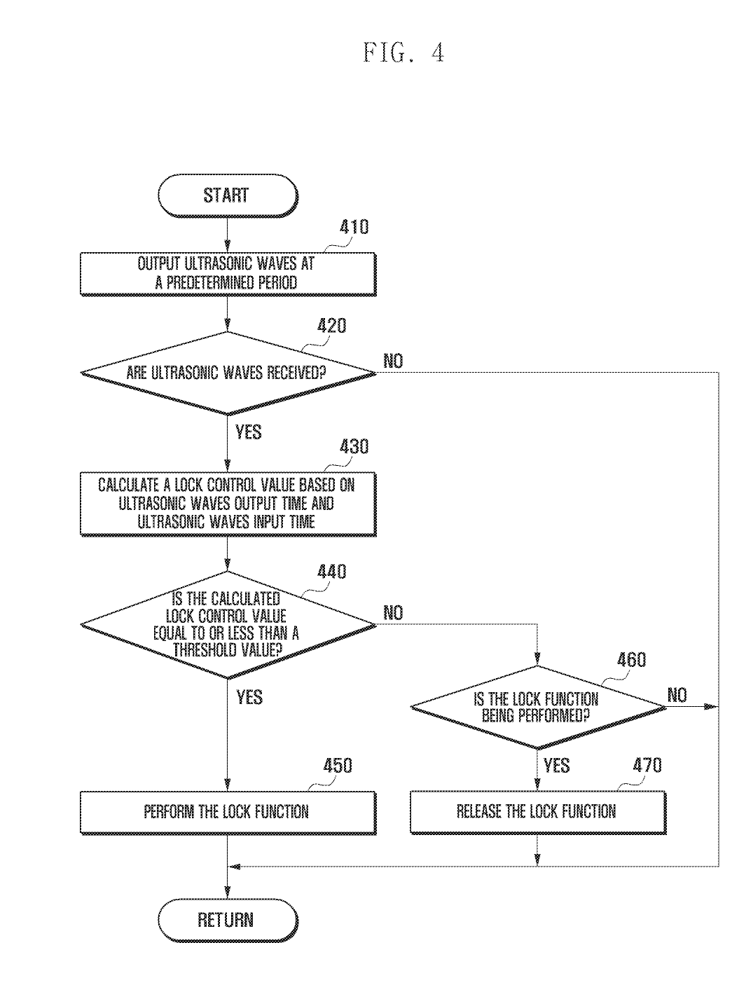

When the communication event is performed at step 320, the control unit 150 performs the lock function in step 330 by using the ultrasonic waves inputted or outputted. Step 330 is described below in more detail with reference to FIG. 4. The control unit 150 determines whether termination of the communication event is selected in step 340. If the communication event is not terminated, the control unit 150 returns to step 330. If the communication event is terminated, the control unit 150 proceeds to step 350 in order to release the lock function performed at step 330.

The above description briefly describes a procedure of performing the lock function by using the ultrasonic waves inputted or outputted during the performing of the communication event. Hereafter, an exemplary procedure of performing a lock function by using the input or output ultrasonic waves is described with reference to FIG. 4.

FIG. 4 illustrates a procedure of performing a lock function according to an exemplary embodiment of the present invention.

Referring to FIG. 4, when the communication event is performed, the control unit 150 outputs the ultrasonic waves according to a predetermined period by controlling the speaker 123 of the audio processing unit 120 in step 410. Next, the control unit 150 determines whether the ultrasonic waves are received through the microphone 125 of the audio processing unit 120 in step 420.

If the ultrasonic waves are received through the microphone 125 the control unit 150 proceeds to step 430. In step 430, the control unit 150 calculates a lock control value based on an output time of the ultrasonic waves output through the speaker 123 and an input time of the ultrasonic waves input through the microphone 125. Here, the lock control value can be a time difference between the output time and the input time of the ultrasonic waves. Alternatively, the lock control value can be a distance the ultrasonic waves have travelled.

Next, the control unit 150 determines whether the calculated lock control value is equal to or less than a preset threshold in step 440. If the calculated lock control value is equal to or less than the preset threshold, the control unit controls the touch screen 130 to perform the lock function in step 450. On the other hand, if the calculated lock control value is greater than the preset threshold value, the control unit 150 proceeds to step 460 in order to determine whether the lock function is activated on the touch screen 130 or is being performed. If the lock function is activated, the control unit 150 releases the lock function in step 470. The control unit 150 repeats the steps described in FIG. 4 until the communication event is terminated.

It is described in the exemplary embodiments herein that the portable terminal has the touch screen 130 as an input unit. However, the present invention is not limited thereto, and the present invention can be applied to a portable terminal that has the display unit 133 and a separate input unit or a variety of other suitable input units. More specifically, when the communication event is performed in a portable terminal having the display unit 133 and the separate input unit, the portable terminal periodically outputs the ultrasonic waves through the speaker 123. Also, the portable terminal determines whether the ultrasonic waves are received through the microphone 125. If the ultrasonic waves are received through the microphone 125, then, the portable terminal determines the output time of the ultrasonic waves and the input time of the ultrasonic waves. Next, the portable terminal calculates the lock control value based on the output time and the input time of the ultrasonic waves. By using the calculated lock control value, the portable terminal can cut off a power supply to at least one of the input unit and the display unit 133.

According to the present exemplary embodiments of invention, the function of a proximity sensor can be replaced by using a basic element of the portable terminal Accordingly, an increased price and an increased number of components of the portable terminal when employing the proximity sensor can be avoided. Also, by replacing the function of the proximity sensor using a basic element of the portable terminal, another component other than the proximity sensor can be included to perform a different function.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method of controlling a function of a portable terminal having a touch screen, the method comprising:
outputting ultrasonic waves through a speaker when a communication event is performed;
determining whether the outputted ultrasonic waves are inputted through a microphone; and
performing a lock function of the touch screen when the ultrasonic waves are inputted through the microphone.

2. The method according to claim 1, wherein the performing of the lock function of the touch screen comprises:
identifying an output time of the outputted ultrasonic waves and an input time of the inputted ultrasonic waves, when the inputted ultrasonic waves are inputted through the microphone;
calculating a lock control value based on the identified output time of the outputted ultrasonic waves and the identified input time of the inputted ultrasonic waves; and
performing the lock function according to the calculated lock control value.

3. The method according to claim 2, wherein the performing of the lock function according to the calculated lock control value comprises:
determining whether the calculated lock value is equal to or less than a preset threshold value to perform the lock function;
determining whether the lock function is performed if the calculated lock value is greater than the preset threshold value; and
releasing the lock function if the lock function is performed when the calculated lock value is greater than the preset threshold value.

4. The method according to claim 3, wherein the performing of the lock function according to the calculated lock control value further comprises performing the lock function if the calculated lock value is equal to or lower than a preset threshold value.

5. The method according to claim 1, wherein the communication event is one of a call originating event or a call receiving event.

6. The method according to claim 1, further comprising:
determining if the communication event is terminated;
continuing the performing of the lock function if the communication event is not terminated; and
releasing the lock function if the communication event is terminated.

7. The method of claim 1, further comprising determining if the outputted ultrasonic waves are similar to the inputted ultrasonic waves.

8. The method of claim 1, wherein the outputting of the ultrasonic waves comprises outputting the ultrasonic waves according to a predetermined period.

9. A portable terminal comprising:
an audio processing unit for outputting ultrasonic waves through a speaker and for receiving the outputted ultrasonic waves through a microphone, when a communication event is performed;
a touch screen for performing a lock function according to the ultrasonic waves inputted and outputted through the audio processing unit, when the communication event is performed; and
a control unit for calculating a lock control value for performing the lock function according to an output time of the ultrasonic waves outputted through the speaker and an input time of the ultrasonic waves inputted through the microphone, and for controlling the touch screen based on the calculated lock control value to perform the lock function.

10. The portable terminal according to claim 9, wherein the control unit determines whether the calculated lock value is equal to or less than a preset threshold value in order to perform the lock function.

11. The portable terminal according to claim 10, wherein the control unit is for determining whether the lock function is performed on the touch screen if the calculated lock value is greater than the preset threshold value, and
wherein the control unit releases the lock function if the lock function is performed on the touch screen.

12. The portable terminal according to claim 9, wherein the communication event is one of a call originating event or a call receiving event.

13. The portable terminal according to claim 9, wherein the control unit determines if the outputted ultrasonic waves are similar to the inputted ultrasonic waves.

14. The portable terminal according to claim 9, wherein the audio processing unit outputs the ultrasonic waves according to a predetermined period.

15. A portable terminal of a wireless communication system, the portable terminal comprising:
an audio processing unit for outputting and inputting ultrasonic waves, the audio processing unit comprising:
a speaker for the outputting of the ultrasonic waves; and
a microphone for the receiving of the inputted ultrasonic waves; and
a control unit for controlling the outputting and inputting of the ultrasonic waves and for determining an output time of the ultrasonic waves outputted through the speaker and for determining an input time of the ultrasonic waves inputted through the microphone.

16. The portable terminal of claim 15, further comprising a touch screen for performing a lock function according to the ultrasonic waves inputted and outputted through the audio processing unit when a communication event is performed on the portable terminal

17. The portable terminal of claim 16, wherein the control unit calculates a lock control value for the performing of the lock function according to the determined output time and the determined input time of the ultrasonic waves, and
wherein the controller controls the touch screen according to the calculated lock control value in order to perform the lock function.

18. The portable terminal according to claim 17, wherein the control unit determines whether the calculated lock value is equal to or less than a preset threshold value in order to perform the lock function.

19. The portable terminal according to claim 17, wherein the control unit determines whether the lock function is performed on the touch screen if the calculated lock value is greater than the preset threshold value, and
wherein the control unit releases the lock function if the lock function is performed on the touch screen.

20. The portable terminal according to claim 16, wherein the communication event comprises one of a call originating event or a call receiving event.

21. The portable terminal according to claim 15, wherein the control unit determines if the outputted ultrasonic waves are similar to the inputted ultrasonic waves.

22. The portable terminal according to claim 15, wherein the audio processing unit outputs the ultrasonic waves according to a predetermined period.
